(19) United States
(12) Patent Application Publication
(10) Pub. No.: US 2020/0294009 A1
(43) Pub. Date: Sep. 17, 2020

(54) BLOCKCHAIN-BASED STATE MACHINE MAINTENANCE

(71) Applicant: Alibaba Group Holding Limited, George Town (KY)

(72) Inventors: Longsheng Qing, Hangzhou (CN); Ge Jin, Hangzhou (CN); Zhen Sun, Hangzhou (CN); Xueqing Yang, Hangzhou (CN); Zhenzhong Meng, Hangzhou (CN); Yu Chu, Hangzhou (CN); Huaiyong Li, Hangzhou (CN)

(73) Assignee: Alibaba Group Holding Limited, George Town (KY)

(21) Appl. No.: 16/888,471

(22) Filed: May 29, 2020

Related U.S. Application Data
(63) Continuation of application No. PCT/CN2020/078236, filed on Mar. 6, 2020.

(30) Foreign Application Priority Data
Jul. 31, 2019 (CN) 201910703780.9
Jul. 31, 2019 (CN) 201910704676.1

(51) Int. Cl. G06Q 20/10; G06Q 20/40; G06F 9/448; H04L 9/06

(52) U.S. Cl. CPC G06Q 20/102; G06Q 20/407; H04L 2209/38; H04L 9/0637; G06F 9/4498

(57) ABSTRACT

The present specification provides blockchain-based state machine maintenance methods and apparatuses. In one implementation, the method includes: receiving, by a blockchain node, an operation transaction for a target electronic bill, wherein the blockchain node maintains a state machine corresponding to an electronic bill stored on a blockchain, wherein the state machine comprises multiple bill states in a life cycle of the electronic bill and operation data for triggering switching of the electronic bill from one bill state to another; in response to receiving the operation transaction, initiating a consensus process for the operation transaction; publishing consensus data related to the consensus process based on the operation transaction for the target electronic bill to the blockchain; determining monitored operation data matches the operation data in the state machine; and switching a bill state of the target electronic bill in the state machine based on the monitored operation data.

### CROSS-REFERENCE TO RELATED APPLICATIONS

This application is a continuation of PCT Application No. PCT/CN2020/078236, filed on Mar. 6, 2020, which claims priority to Chinese Patent Application No. 201910704676.1, filed on Jul. 31, 2019, and Chinese Patent Application No. 201910703780.9, filed on Jul. 31, 2019 and each application is hereby incorporated by reference in its entirety.

### TECHNICAL FIELD

One or more implementations of the present specification relate to the field of blockchain technologies, and in particular, to blockchain-based state machine maintenance methods and apparatuses.

### BACKGROUND

The blockchain technology, also referred to as distributed ledger technology, is an emerging technology in which multiple computing devices jointly participate in recording a ledger and jointly maintain a complete distributed database. Due to its features of decentralization, openness and transparency, participation in database recording by each computing device, and fast data synchronization among computing devices, the blockchain technology has been widely used in various fields.

### SUMMARY

In view of the previous description, the present application discloses blockchain- based state machine maintenance methods and apparatuses, electronic devices, and storage media.

To achieve the previous objective, one or more implementations of the present specification provide the following technical solutions:

According to a first aspect of one or more implementations of the present specification, a blockchain-based state machine maintenance method is provided, where the method is applied to a blockchain node; the blockchain node maintains a state machine corresponding to an electronic bill stored on the blockchain; the state machine includes multiple bill states in a life cycle of the electronic bill, and operation data for triggering switching of the electronic bill from one bill state to another; and the method includes the following: receiving an operation transaction for a target electronic bill; in response to the operation transaction, publishing operation data that passed consensus and is relating to the operation transaction for the target electronic bill to the blockchain for storage; when monitoring that the operation data for the target electronic bill has been stored on the blockchain, determining whether the monitored operation data matches the operation data in the state machine; and if yes, switching a bill state of the target electronic bill in the state machine based on the monitored operation data.

Optionally, the operation transaction is a ledger transaction that includes the operation data for performing an operation on the target electronic bill; the operation data relating to the operation transaction for the target electronic bill is the operation data included in the operation transaction; and the publishing, in response to the operation transaction, operation data that passed consensus and is relating to the operation transaction for the target electronic bill to the blockchain for storage includes the following: in response to the operation transaction, publishing the operation transaction that passed consensus to the blockchain for storage.

Optionally, the operation transaction is a transaction for invoking a smart contract; the operation data relating to the operation transaction for the target electronic bill is operation data generated by performing an operation on the target electronic bill by invoking the smart contract; and the publishing, in response to the operation transaction, operation data that passed consensus and is relating to the operation transaction for the target electronic bill to the blockchain for storage includes the following: performing an operation on the target electronic bill by invoking a bill processing logic declared in the smart contract that's published on the blockchain; and publishing the operation data generated by performing an operation on the target electronic bill to the blockchain for storage.

Optionally, the method further includes the following: receiving a query request that is sent by an inquirer for a bill state of the target electronic bill; and obtaining a current bill state of the target electronic bill in the state machine, and returning the obtained bill state to the inquirer.

Optionally, the method further includes the following: if the bill state of the target electronic bill in the state machine is switched, sending the switched bill state of the electronic bill to a bill state subscriber corresponding to the state machine.

Optionally, the method further includes the following: receiving a state subscribing request for the target electronic bill; determining whether a sender of the state subscribing request is a bill-related party of the target electronic bill; and if yes, using the sender as the bill state subscriber.

Optionally, states of the state machine include an unreimbursed state, a reimbursement locked state, a reimbursed state, a posted state, a reverse invoice issued state, a printed state, and a voided state in the life cycle of the electronic bill; the operation data for switching the bill state of the target electronic bill in the state machine from the unreimbursed state to the reimbursement locked state is triggered as identification information of the target electronic bill included in a reimbursement transaction for the target electronic bill; the operation data for switching the bill state of the target electronic bill in the state machine from the reimbursement locked state to the reimbursed state is triggered as a reimbursement result for the target electronic bill; the operation data for switching the bill state of the target electronic bill in the state machine from the reimbursed state to the posted state is triggered as a posting result for the target electronic bill; the operation data for switching the bill state of the target electronic bill in the state machine from the unreimbursed state to the reverse invoice issued state is triggered as a reversal result for the target electronic bill; the operation data for switching the bill state of the target electronic bill in the state machine from the unreimbursed state to the printed state is triggered as a printing result for the target electronic bill; and the operation data for switching the bill state of the target electronic bill in the state machine from the unreimbursed state to the voided state is triggered as a voiding result for the target electronic bill.

According to a second aspect of one or more implementations of the present specification, a blockchain-based state machine maintenance apparatus is provided, where the apparatus is applied to a blockchain node; the blockchain node maintains a state machine corresponding to an electronic bill stored on the blockchain; the state machine includes multiple bill states in a life cycle of the electronic bill, and operation data for triggering switching of the electronic bill from one bill state to another; and the apparatus includes the following: a first receiving unit, configured to receive an operation transaction for a target electronic bill; a storage unit, configured to: in response to the operation transaction, publish operation data that passed consensus and is relating to the operation transaction for the target electronic bill to the blockchain for storage; and a switching unit, configured to: when monitoring that the operation data for the target electronic bill has been stored on the blockchain, determine whether the monitored operation data matches the operation data in the state machine; and if yes, switch a bill state of the target electronic bill in the state machine based on the monitored operation data.

Optionally, the operation transaction is a ledger transaction that includes the operation data for performing an operation on the target electronic bill; the operation data relating to the operation transaction for the target electronic bill is the operation data included in the operation transaction; and the storage unit is configured to: in response to the operation transaction, publish the operation transaction that passed consensus to the blockchain for storage.

Optionally, the operation transaction is a transaction for invoking a smart contract; the operation data relating to the operation transaction for the target electronic bill is operation data generated by performing an operation on the target electronic bill by invoking the smart contract; and the storage unit is configured to: perform an operation on the target electronic bill by invoking a bill processing logic declared in the smart contract that's published on the blockchain; and publish the operation data generated by performing an operation on the target electronic bill to the blockchain for storage.

Optionally, the apparatus further includes the following: a second receiving unit, configured to receive a query request that is sent by an inquirer for a bill state of the target electronic bill; and a returning unit, configured to obtain a current bill state of the target electronic bill in the state machine, and return the obtained bill state to the inquirer.

Optionally, the apparatus further includes the following: a pushing unit, configured to: if the bill state of the target electronic bill in the state machine is switched, push the switched bill state of the electronic bill to a bill state subscriber corresponding to the state machine.

Optionally, the pushing unit is specifically configured to: receive a state subscribing request for the target electronic bill; determine whether a sender of the state subscribing request is a bill-related party of the target electronic bill; and if yes, use the sender as the bill state subscriber.

Optionally, states of the state machine include an unreimbursed state, a reimbursement locked state, a reimbursed state, a posted state, a reverse invoice issued state, a printed state, and a voided state in the life cycle of the electronic bill; the operation data for switching the bill state of the target electronic bill in the state machine from the unreimbursed state to the reimbursement locked state is triggered as identification information of the target electronic bill included in a reimbursement transaction for the target electronic bill; the operation data for switching the bill state of the target electronic bill in the state machine from the reimbursement locked state to the reimbursed state is triggered as a reimbursement result for the target electronic bill; the operation data for switching the bill state of the target electronic bill in the state machine from the reimbursed state to the posted state is triggered as a posting result for the target electronic bill; the operation data for switching the bill state of the target electronic bill in the state machine from the unreimbursed state to the reverse invoice issued state is triggered as a reversal result for the target electronic bill; the operation data for switching the bill state of the target electronic bill in the state machine from the unreimbursed state to the printed state is triggered as a printing result for the target electronic bill; and the operation data for switching the bill state of the target electronic bill in the state machine from the unreimbursed state to the voided state is triggered as a voiding result for the target electronic bill.

According to a third aspect of one or more implementations of the present specification, an electronic device is provided, including the following: a processor; and a memory, configured to store a processor executable instruction, where the processor runs the executable instruction to implement the blockchain-based state machine maintenance method according to any implementation described previously.

According to a fourth aspect of implementations of the present specification, a computer readable storage medium is provided, where the computer readable storage medium stores a computer instruction, and the instruction is executed by a processor to implement the steps of the blockchain-based state machine maintenance method according to any implementation described previously.

As can be seen from the previous technical solutions, the blockchain node maintains multiple bill states of the electronic bill in the whole life cycle, so that the participants who create the blockchain can jointly maintain the bill states of the electronic bill on the blockchain through consensus, and understand the current state of the electronic bill by using the blockchain, thus determining whether a specific operation can be performed on the electronic bill. For example, before reimbursing an electronic bill, a reimbursing company can query whether the electronic bill has been reimbursed, voided, reversed, etc. by using the state machine maintained on the blockchain, thus improving the efficiency of reimbursing the electronic bill, and alleviating problems such as duplicated claims and reimbursement error.

### BRIEF DESCRIPTION OF DRAWINGS

FIG. 1 is a schematic diagram of creating a smart contract, according to an example implementation;

FIG. 2 is a schematic diagram of invoking a smart contract, according to an example implementation;

FIG. 3 is a schematic diagram of creating a smart contract and invoking a smart contract, according to an example implementation;

FIG. 4 is a schematic diagram of switching a bill state of an electronic bill, according to an example implementation;

FIG. 5 is a flowchart illustrating a blockchain-based state machine maintenance method, according to an example implementation;

FIG. 6 is a flowchart illustrating a blockchain-based bill state pushing method, according to an example implementation;

FIG. 7 is a schematic diagram illustrating an overall architecture of a blockchain- based state machine maintenance solution, according to an example implementation;

FIG. 8 is a schematic diagram illustrating an overall architecture of another blockchain-based state machine maintenance solution, according to an example implementation;

FIG. 9 is an interactive diagram of subscribing to a bill state, according to an example implementation;

FIG. 10 is an interactive diagram illustrating a bill state pushing method, according to an example implementation;

FIG. 11 is an interactive diagram illustrating another bill state pushing method, according to an example implementation;

FIG. 12 is an interactive diagram of obtaining a bill state, according to an example implementation;

FIG. 13 is an interactive diagram illustrating reimbursement verification, according to an example implementation;

FIG. 14 is a schematic structural diagram illustrating a device, according to an example implementation; and

FIG. 15 is a block diagram illustrating a blockchain-based bill state pushing apparatus, according to an example implementation.

### DESCRIPTION OF IMPLEMENTATIONS

Example implementations are described in detail here, and examples of the example implementations are presented in the accompanying drawings. When the following description relates to the accompanying drawings, unless specified otherwise, same numbers in different accompanying drawings represent same or similar elements. Example implementations described in the following do not represent all implementations consistent with one or more implementations of the present specification. On the contrary, the implementations are only examples of apparatuses and methods that are described in the appended claims in detail and consistent with some aspects of one or more implementations of the present specification.

It is worthwhile to note that the steps of the corresponding method are not necessarily performed in the order shown and described in the present specification in other implementations. In some other implementations, the method can include more or less steps than those described in the present specification. In addition, a single step described in the present specification can be divided into multiple steps in other implementations for description; and multiple steps described in the present specification can be combined into a single step for description in other implementations.

Blockchains are generally categorized into three types: public blockchain, private blockchain, and consortium blockchain. In addition, there are multiple types of combinations, such as a combination of private blockchain and consortium blockchain, or a combination of consortium blockchain and public blockchain, etc. The public blockchain has the highest degree of decentralization. Example public blockchains can include Bitcoins and Ethereum. Participants joined the public blockchain can read data records on the blockchain, participate in transactions, and contend for the mining right in new blocks.

Furthermore, participants (i.e., blockchain nodes) can join or exit the blockchain network freely and perform related operations. On the contrary, in the private blockchain, write permissions of the blockchain network are controlled by a certain organization or entity, and the data read permissions are specified by the organization. In short, the private blockchain can be a weakly-centralized system. Strict restrictions are imposed on the participating nodes, and the quantity of the participating nodes is small. This type of blockchain is more suitable for use within a particular entity.

The consortium blockchain is a blockchain between the public blockchain and the private blockchain, and can implement “partial decentralization”. Each node in the consortium blockchain usually corresponds to a physical entity or organization. Participants join the network through authorization and form a stakeholder consortium to jointly maintain blockchain operation.

Each of the public blockchain, the private blockchain, and the consortium blockchain can provide a function of a smart contract. A smart contract on the blockchain is a contract that can be triggered and executed by a transaction in a blockchain system. Smart contracts can be defined in the form of code.

Ethereum is used as an example. Ethereum supports users in creating and invoking some complex logics in an Ethereum network. It is the biggest challenge that distinguishes Ethereum from the Bitcoin blockchain technology. As a programmable blockchain, the core of Ethereum is an Ethereum virtual machine (EVM). Each Ethereum node can run the EVM. The EVM is a Turing-complete virtual machine, meaning that various complex logics can be implemented by using the EVM. The user publishes and invokes a smart contract in the Ethereum by running the EVM. In fact, the virtual machine directly runs virtual machine code (virtual machine bytecode, which is briefly referred to “bytecode” in the following). A smart contract deployed on the blockchain can be in the form of a bytecode.

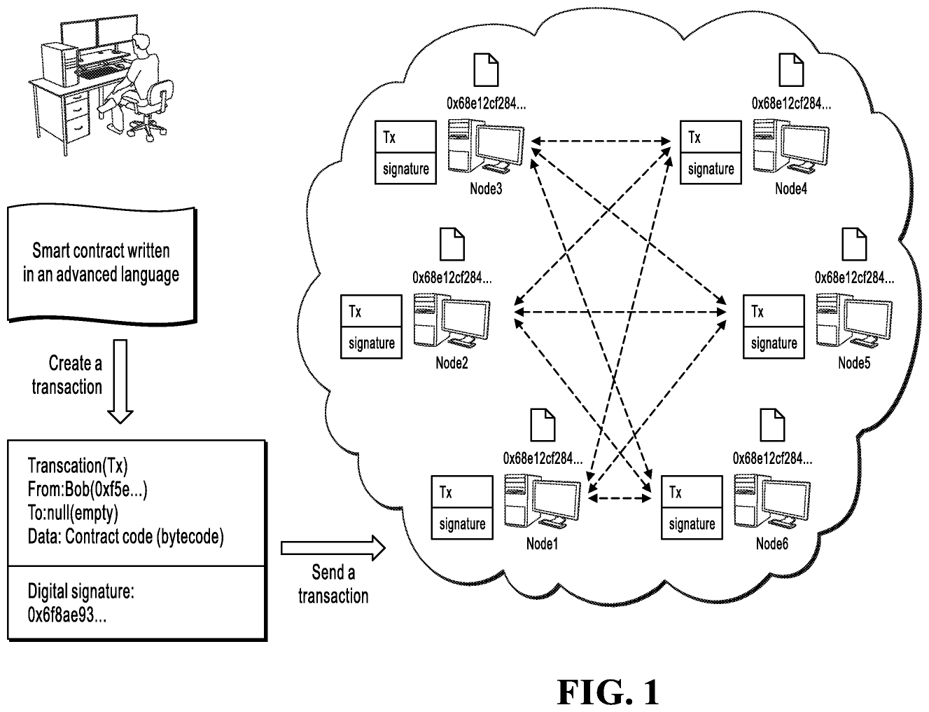

As shown in FIG. 1, after Bob sends a transaction that includes information for creating a smart contract to an Ethereum network, an EVM of node 1 can execute the transaction and generate a corresponding contract. In FIG. 1, “0x68e12cf284 . . . ” represents an address of the contract, the DATA field of the transaction can store a bytecode and the TO field of the transaction is an empty account. After consensus is reached among nodes by using the consensus mechanism, the contract is successfully created and can be invoked by subsequent users.

After the contract is created, a contract account corresponding to the smart contract appears on the blockchain and has a specific address. Contract code and account storage will be saved in the contract account. Implementation of the smart contract is controlled by the contract code, whereas the account storage of the smart contract retains a status of the contract. In other words, the smart contract causes a virtual account on the blockchain that includes the contract code and the account storage.

As described previously, the DATA field of the transaction that includes the information for creating the smart contract can store the bytecode of the smart contract. The bytecode includes a series of bytecodes, and each bytecode can identify one operation. Based on considerations of development efficiency, readability, etc., developers can select an advanced language to write the smart contract code instead of directly writing the bytecode. For example, advanced languages such as Solidity, Serpent, and LLL are used. The smart contract code written in an advanced language can be compiled by a compiler to generate a bytecode that can be deployed on the blockchain.

The Solidity language is used as an example. The contract written in the Solidity language is similar to a class in the object-oriented programming language. Multiple members can be declared in a contract, including a state variable, a function, a function modifier, an event, etc. The state variable is a value that is permanently stored in the account storage of the smart contract, and is used to save the status of the contract.

Generally, after a smart contract is deployed on the blockchain, a storage state corresponding to the state variable in the contract code of the smart contract is a plaintext, and its state is visible to any person, without setting and capability of privacy protection.

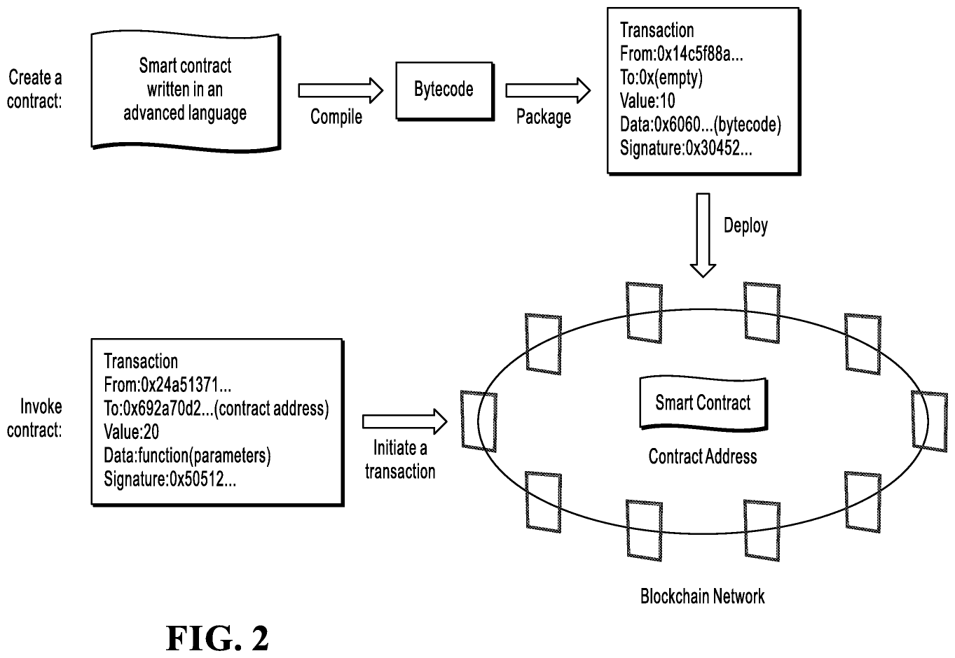

As shown in FIG. 2, Ethereum is still used as an example. After Bob sends a transaction that includes information for invoking a smart contract to the Ethereum network, the EVM of node 1 can execute the transaction and generate a corresponding contract. In FIG. 2, the FROM field of the transaction represents an address of an account that initiates the invoking of the smart contract; “0x692a70d2 . . . ” in the TO field represents an address of the invoked smart contract; the VALUE field represents a value of an Ethercoin in Ethereum; and the DATA field of the transaction stores a method and parameters for invoking the smart contract. After the smart contract is invoked, a value of balance may change. Later, a certain client can view the current value of balance by using a certain blockchain node (such as node 6 in FIG. 2).

The smart contract can be executed independently on each node in the blockchain network in a specified way, and all execution records and data are stored on the blockchain. Therefore, after such transaction is completed, the blockchain stores a transaction that cannot be tampered with and will not be lost.

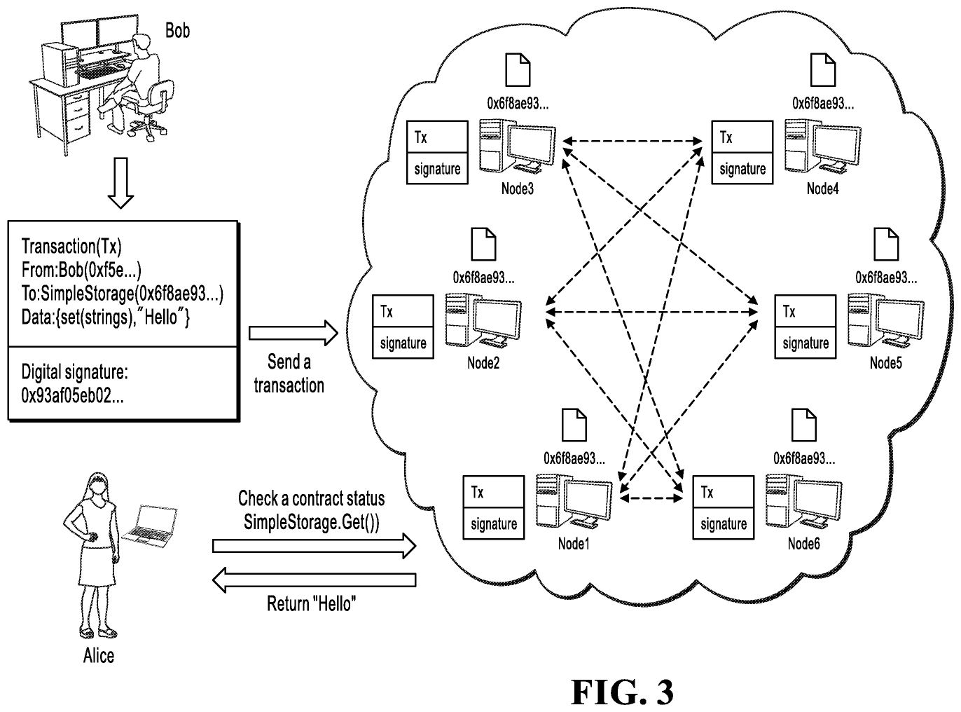

FIG. 3 is a schematic diagram of creating a smart contract and invoking a smart contract. Creating a smart contract in Ethereum includes processes such as writing a smart contract, converting the smart contract into a bytecode, deployment to the blockchain, etc. Invoking a smart contract in Ethereum is to initiate a transaction that points to the address of the smart contract. The code of the smart contract is executed in the virtual machine of each node in the Ethereum network in a distributed way.

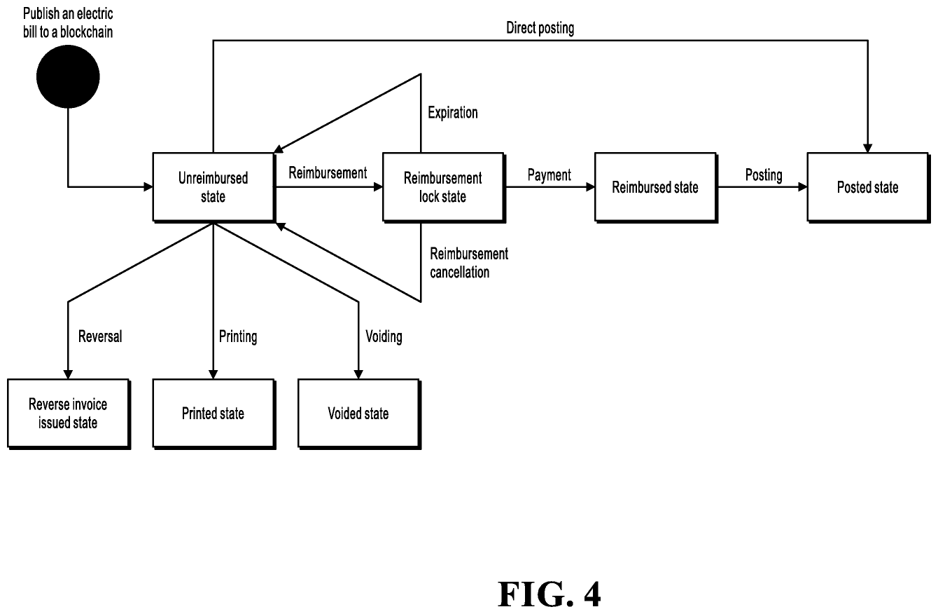

FIG. 4 is a schematic diagram of switching a bill state of an electronic bill, according to an example implementation of the present application. As shown in FIG. 4, after issuing an electronic bill, an invoicing party publishes the electronic bill to the blockchain for storage where data published to the blockchain is stored in the blockchain, creating an immutable record to be verified later. At this time, the electronic bill is in an unreimbursed state. When a bill-related party (e.g., a party claiming for reimbursement) initiates reimbursement for the electronic bill, the electronic bill is in a reimbursement locked state, so as to prevent other parties from claiming for reimbursement of the electronic bill, thus alleviating a problem of duplicate claims. Further, when payment is completed (an amount corresponding to the electronic bill is transferred to a specified account of the bill-related party), the electronic bill is in a reimbursed state. When posting is completed, the electronic bill is in a posted state.

The electronic bill can also be posted directly without needing the reimbursement process, and then is switched from the unreimbursed state to the posted state. After the electronic bill is switched from the unreimbursed state to the reimbursement locked state, if no reimbursement result is monitored within a predetermined period, the blockchain node updates the electronic bill from the reimbursement locked state to the unreimbursed state (i.e., an “expiration” process in the figure). Similarly, after the electronic bill is switched from the unreimbursed state to the reimbursement locked state, if verification indicates that the electronic bill does not satisfy a bill reimbursement condition, the blockchain node updates the electronic bill from the reimbursement locked state to the unreimbursed state (i.e., a “reimbursement cancellation” process in the figure).

The electronic bill in the unreimbursed state can be reimbursed, and can also be reversed, printed (by using a blank template bill), voided, etc., and then the electronic bill is switched to a reverse invoice issued state, a printed state, or a voided state, respectively. The unreimbursed state, the reimbursement locked state, the reimbursed state, and the posted state are valid states of the electronic bill. The reverse invoice issued state, the printed state, and the voided state are invalid states of the electronic bill. No operation can be performed on the electronic bill in an invalid state.

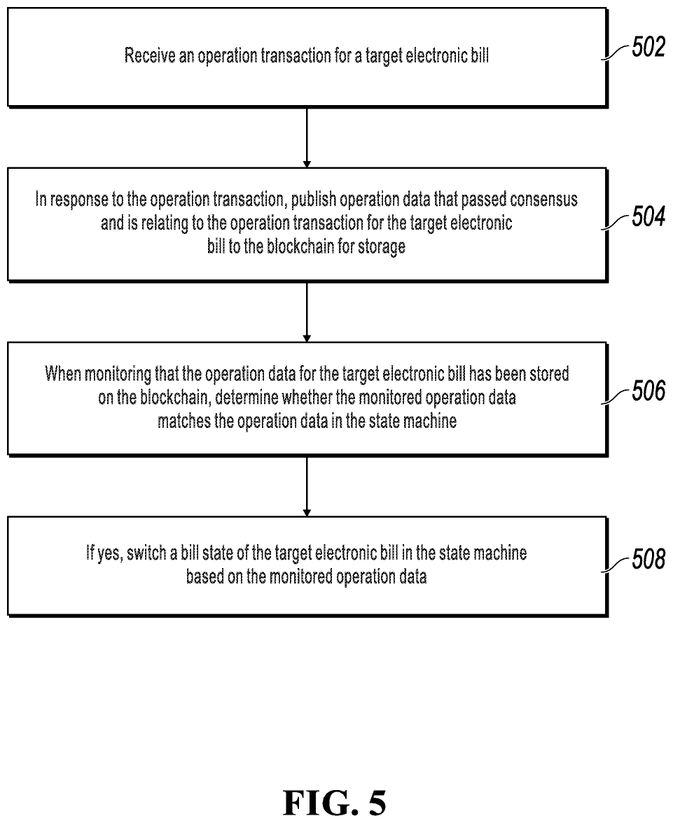

Based on the previously described mechanism for switching the bill state of the electronic bill, the present specification provides a blockchain-based state machine maintenance method. FIG. 5 is a flowchart illustrating a blockchain-based state machine maintenance method, according to an example implementation. As shown in FIG. 5, the maintenance method is applied to a blockchain node; the blockchain node maintains a state machine corresponding to an electronic bill stored on the blockchain; the state machine includes multiple bill states in a life cycle of the electronic bill, and operation data for triggering switching of the electronic bill from one bill state to another. The maintenance method can include the following steps:

Step 502: Receive an operation transaction for a target electronic bill.

In the present implementation, a bill-related party can perform an operation on an electronic bill stored on the blockchain. Operations include reimbursement, voiding, reversal, printing, etc. For example, a payer of the electronic bill can reimburse the electronic bill; an invoicing party can reverse, void, or print the electronic bill.

In one case, the bill-related party can perform an operation on the electronic bill in real world, and then publish operation data (which can be understood as an operation result) generated by performing the operation to the blockchain for storage. In such case, the operation transaction is a ledger transaction that includes the operation data for performing an operation on the target electronic bill, and the operation data relating to the operation transaction for the target electronic bill is the operation data included in the operation transaction. After receiving the operation transaction for the target electronic bill, the blockchain node can publish, in response to the operation transaction, the operation transaction that passed consensus to the blockchain for storage.

In another case, a smart contract can be deployed on the blockchain to perform an operation on the electronic bill. For example, the blockchain is a consortium blockchain. A member of the consortium blockchain can deploy a smart contract on the consortium blockchain for performing an operation on the electronic bill, and declare a bill processing logic in the smart contract. After the development of the smart contract is completed, the member of the consortium blockchain can publish the smart contract to the consortium blockchain by using any node device on the consortium blockchain, and store the smart contract in a distributed database (i.e., a distributed ledger) of the consortium blockchain after the smart contract is agreed upon by some designated member node devices on the consortium blockchain (e.g., some authoritative node devices having the mining right specified on the consortium blockchain). Later, a user can access a client of any node device and submit a transaction to the smart contract stored on the consortium blockchain, to initiate invoking of the smart contract and trigger execution of a related service logic on the consortium blockchain.

Based on the previously described deployment of the smart contract, the operation transaction is the transaction for invoking the smart contract (including the address of the invoked smart contract), and the operation data relating to the operation transaction for the target electronic bill is the operation data (which can be understood as the operation result) generated by performing an operation on the target electronic bill by invoking the smart contract. After receiving the operation transaction for the target electronic bill, the blockchain node invokes the bill processing logic declared in the smart contract that's published on the blockchain, performs an operation on the target electronic bill, and publishes the operation data generated by performing an operation on the target electronic bill to the blockchain for storage.

It is worthwhile to note that, a type of the request initiated on the blockchain by the user accessing the blockchain can be a transaction used in the conventional blockchain. Certainly, the type of the request initiated on the blockchain by the user accessing the blockchain can also be another form of an instruction, a message, etc. that has a standard data structure other than a transaction. It is not specially limited in one or more implementations of the present specification. The following implementations are described by using an example in which the request initiated on the blockchain by the user accessing the blockchain is a transaction.

Step 504: In response to the operation transaction, publish operation data that passed consensus and is relating to the operation transaction for the target electronic bill to the blockchain for storage.

In the present implementation, a user client accessing the blockchain can package data into a standard transaction format supported by the blockchain and then publish the data to the blockchain; a node device (which is a blockchain node) in the blockchain can, based on the carried consensus algorithm and together with other node devices, perform consensus on the transactions published by the user client to the blockchain, so as to generate a latest block for the blockchain.

Step 506: When monitoring that the operation data for the target electronic bill has been stored on the blockchain, determine whether the monitored operation data matches the operation data in the state machine.

Step 508: If yes, switch a bill state of the target bill in the state machine based on the monitored operation data.

In the present implementation, if the bill state of the target electronic bill in the state machine is switched, the switched bill state of the electronic bill is pushed to the bill state subscriber corresponding to the state machine.

In the present implementation, based on the previously described state machine maintenance process, the inquirer can send a query request for the bill state of the target electronic bill to the blockchain node by using the client, to obtain the current state of the target electronic bill. Then the blockchain node can obtain the current bill state of the maintained state machine and return the obtained bill state to the inquirer. After receiving the query request, the blockchain node can first check whether the inquirer has permission to obtain the bill state of the target electronic bill. For example, the blockchain node can first check whether the inquirer is a bill-related party (an invoicing party, a supervising party, a claiming party, etc.) of the target electronic bill; and if yes, obtain and return the bill state. Certainly, a specific verification method can be set flexibly based on the actual situation, which is not limited in one or more implementations of the present specification.

In the present implementation, based on the state machine maintenance process in the previously described steps, when the operation is to reimburse, a reimbursement locking mechanism can be further set with reference to the current bill state of the electronic bill recorded by the state machine, to prevent multiple reimbursement initiators from reimbursing the target electronic bill repeatedly.

Before reimbursing the target electronic bill, the reimbursement initiator can send a reimbursement confirmation request for the target electronic bill to the blockchain node, to confirm whether the target electronic bill is allowed to be reimbursed. After receiving the reimbursement confirmation request, the blockchain determines the current bill state of the target electronic bill based on the maintained state machine. When the determined bill state is an unreimbursed state (indicating that no other bill-related party previously initiated reimbursement for the target electronic bill), the bill state of the target electronic bill in the state machine is switched to the reimbursement locked state, and the bill-related party is instructed to reimburse the target electronic bill. When the determined bill state is a reimbursement locked state (indicating that another bill-related party has previously initiated reimbursement for the target electronic bill), the bill-related party is notified that the target electronic bill is in the reimbursement locked state, that is to say, reimbursement for the target electronic bill is prohibited (if the bill-related party reimburses the target electronic bill, duplicated claims occur).

In the present implementation, the state machine can include an unreimbursed state, a reimbursement locked state, a reimbursed state, a posted state, a reverse invoice issued state, a printed state, and a voided state in the life cycle of the electronic bill. The operation data for switching the bill state of the target electronic bill in the state machine from the unreimbursed state to the reimbursement locked state is triggered as identification information of the target electronic bill included in a reimbursement transaction for the target electronic bill. The operation data for switching the bill state of the target electronic bill in the state machine from the reimbursement locked state to the reimbursed state is triggered as a reimbursement result for the target electronic bill. The operation data for switching the bill state of the target electronic bill in the state machine from the reimbursed state to the posted state is triggered as a posting result for the target electronic bill. The operation data for switching the bill state of the target electronic bill in the state machine from the unreimbursed state to the reverse invoice issued state is triggered as a reversal result for the target electronic bill. The operation data for switching the bill state of the target electronic bill in the state machine from the unreimbursed state to the printed state is triggered as a printing result for the target electronic bill. The operation data for switching the bill state of the target electronic bill in the state machine from the unreimbursed state to the voided state is triggered as a voiding result for the target electronic bill.

For example, before reimbursing the target electronic bill, the reimbursement initiator can send a reimbursement confirmation request (including the identification information of the target electronic bill) for the target electronic bill to the blockchain node, so that the blockchain node confirms, by using the bill state of the target electronic bill in the state machine, whether the target electronic bill is allowed to be reimbursed (reimbursement is allowed when the target electronic bill is in the unreimbursed state). In such case, the operation data is the identification information included in the reimbursement confirmation request. When the blockchain node receives the reimbursement confirmation request for the target electronic bill, if the state machine corresponding to the target electronic bill is currently in the unreimbursed state, the state machine is switched to the reimbursement locked state. Similarly, when a smart contract is published on the blockchain to reimburse the target electronic bill, the reimbursement initiator can send a reimbursement transaction (including the identification information of the target electronic bill) to the blockchain node to invoke the smart contract to reimburse the target electronic bill. In such case, the operation data is the identification information of the target electronic bill included in the reimbursement transaction for the target electronic bill. When the blockchain node receives the reimbursement transaction for the target electronic bill, if the state machine corresponding to the target electronic bill is currently in the unreimbursed state, the state machine is switched to the reimbursement locked state.

The operation data can also be an execution result certificate generated by performing an operation on the target electronic bill. For example, when the operation is to reimburse, it can be determined that the electronic bill has been reimbursed, based on the reimbursement receipt (which has been published to the blockchain for storage) obtained after the reimbursement of the electronic bill. If the state machine corresponding to the electronic bill is currently in the reimbursement locked state, the state machine is switched to the reimbursed state. When the operation is reversal, it can be determined that the electronic bill has been reversed, based on the reversal receipt (which has been published to the blockchain for storage) obtained after the reversal of the electronic bill. If the state machine corresponding to the electronic bill is currently in the unreimbursed state, the state machine corresponding to the electronic bill is switched to the reverse invoice issued state. A case in which the operation is of another operation type is similar to the previous example, and details are omitted here for simplicity.

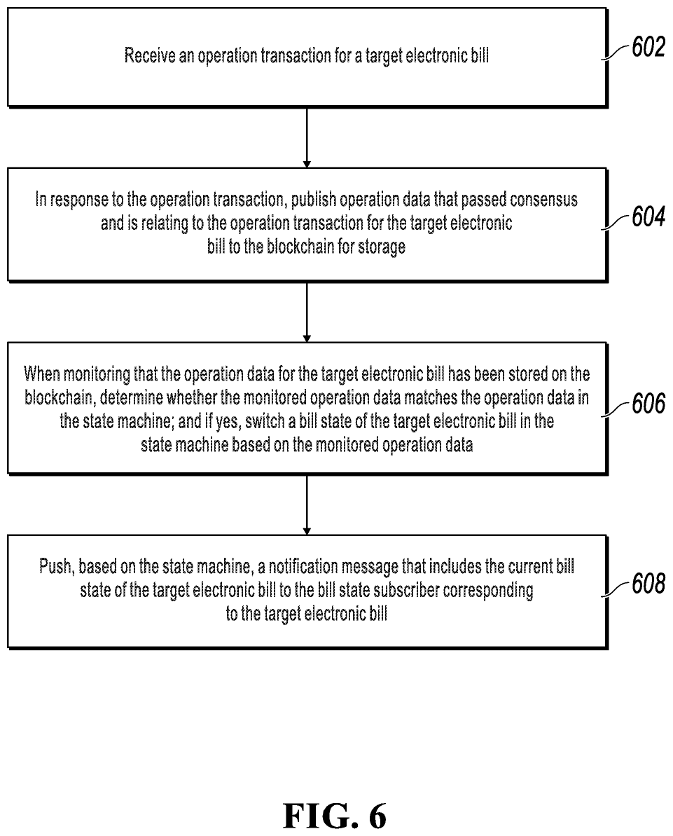

In the technical solutions of the present specification, based on the state machine maintenance in the previously described implementations, a blockchain-based bill state pushing solution can be further provided. FIG. 6 is a flowchart illustrating a blockchain-based bill state pushing method, according to an example implementation. As shown in FIG. 6, the pushing method is applied to a blockchain node; the blockchain node maintains a state machine corresponding to an electronic bill stored on the blockchain; the state machine includes multiple bill states in a life cycle of the electronic bill, and operation data for triggering switching of the electronic bill from one bill state to another. The pushing method can include the following steps:

Step 602: Receive an operation transaction for a target electronic bill.

Step 604: In response to the operation transaction, publish operation data that passed consensus and is relating to the operation transaction for the target electronic bill to the blockchain for storage.

Step 606: When monitoring that the operation data for the target electronic bill has been stored on the blockchain, determine whether the monitored operation data matches the operation data in the state machine; and if yes, switch a bill state of the target electronic bill in the state machine based on the monitored operation data.

It is worthwhile to note that, for a specific process of step 602 to step 606, references can be made to step 502 to step 506 in the implementation shown in FIG. 5. Details are omitted here for simplicity.

Step 608: Push, based on the state machine, a notification message that includes the current bill state of the target electronic bill to the bill state subscriber corresponding to the target electronic bill.

In the present implementation, when the bill-related party subscribes to a state update of the electronic bill, if the state machine corresponding to the electronic bill is switched, a corresponding notification message is actively pushed to the bill-related party to inform the bill-related party of the latest state of the subscribed bill.

The bill-related party can send a state subscribing request to the blockchain node by using a client connected to the blockchain node, so as to subscribe to the state of the electronic bill. The previously described target electronic bill is used as an example. After receiving the state subscribing request for the target electronic bill, the blockchain node can determine whether a sender of the state subscribing request is the bill-related party of the target electronic bill; and if yes, use the sender as the bill state subscriber for the target electronic bill. Certainly, a specific method for verifying whether the target electronic bill can be subscribed can be set flexibly based on the actual situation. For example, only the payer of the target electronic bill is allowed to subscribe, which is not limited in one or more implementations of the present specification.

As can be seen from the previous technical solutions, the blockchain node maintains multiple bill states of the electronic bill in the whole life cycle, so that the participants who create the blockchain can jointly maintain the bill states of the electronic bill on the blockchain through consensus, and understand the current state of the electronic bill by using the blockchain, thus determining whether a specific operation can be performed on the electronic bill. For example, before reimbursing an electronic bill, a reimbursing company can query whether the electronic bill has been reimbursed, voided, reversed, etc. by using the state machine maintained on the blockchain, thus improving the efficiency of reimbursing the electronic bill, and alleviating problems such as duplicated claims and reimbursement error.

Further, based on the bill-related party's subscription mechanism for the electronic bill, when the bill state of the target electronic bill in the state machine is switched, a notification message is actively pushed to the bill state subscriber, so as to inform the bill state subscriber of the latest state change of the subscribed bill. For example, each of an invoicing party, a claiming party, and a payer of the electronic bill can subscribe to the bill state of the electronic bill by using the blockchain. When one of these parties performs a specific operation on the electronic bill, the subscriber can obtain state change information in a timely way by using the blockchain. For example, if the electronic bill of the payer is stolen and reimbursed by a person having the same name, the payer can obtain, in a timely way by using the previously described subscription mechanism, a notification message indicating that the bill has been reimbursed, thus redeeming the loss in time.

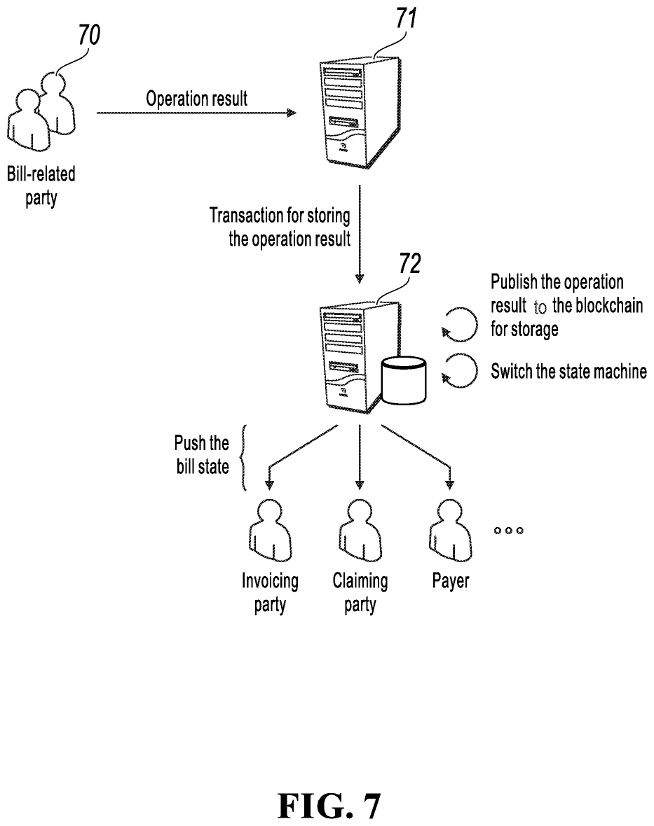

FIG. 7 is a schematic diagram illustrating an overall architecture of a blockchain- based state machine maintenance solution, according to an example implementation. As shown in FIG. 7, a client of the blockchain runs on a server 72, so that the server 72 is configured as a blockchain node. A bill-related party 70 can register an account with the server 72 by using the client 71 in advance to obtain a registered account only corresponding to the bill-related party 70. Then, the bill-related party 70 can log in to the registered account on the client 71. Based on the login information of the registered account on the client 71, the server 72 determines that a binding relationship is established between the registered account (corresponding to the user) and the client 71. The binding relationship that needs to be established is a binding relationship between user information of the bill-related party 70 and device information of the client 71. Based on the binding relationship, when receiving a transaction sent later by the client 71, the server 72 can determine that the transaction corresponds to the bill-related party 70.

The bill-related party 70 can input, by using the client 71, the operation result that is obtained after performing an operation on the target electronic bill in real world, so that the client 71 packages a transaction for storing the operation result, and sends the packaged transaction to the server 72. After receiving the transaction, the server 72 (serving as a blockchain node) publishes the operation result to the blockchain for storage, and switches the bill state of the target electronic bill in the state machine based on the operation result.

When there is a state subscriber for the target electronic bill, after switching the bill state of the target electronic bill in the state machine, the server 72 can actively push a notification message that includes the current bill state of the target electronic bill to the state subscriber. For example, assuming that the state subscribers are the invoicing party, the claiming party, and the payer of the target electronic bill, the server 72 actively pushes a notification message that includes the current bill state of the target electronic bill to the invoicing party, the claiming party, and the payer, respectively.

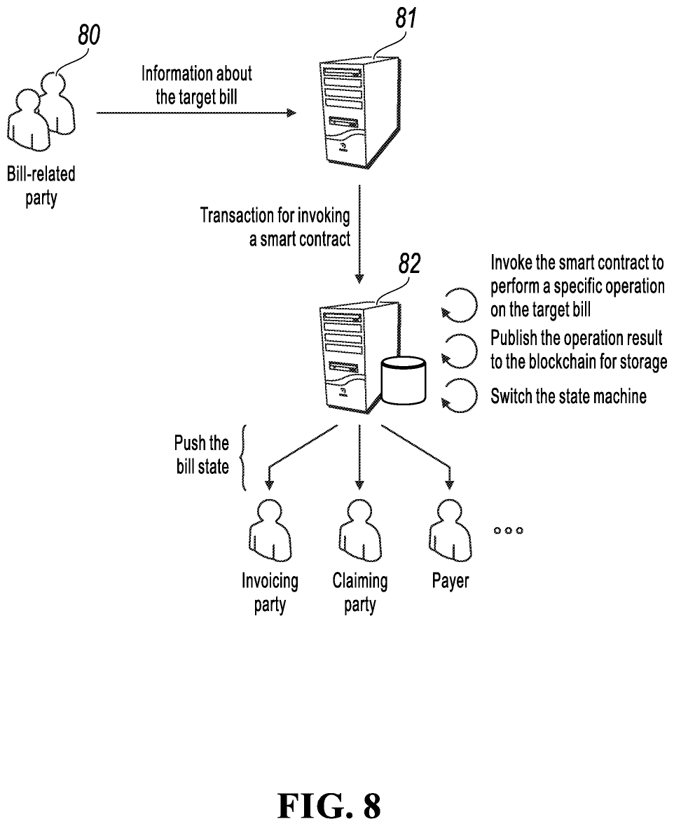

FIG. 8 is a schematic diagram illustrating an overall architecture of another blockchain-based state machine maintenance solution, according to an example implementation. As shown in FIG. 8, a client of the blockchain runs on a server 82, so that the server 82 is configured as a blockchain node, and a smart contract for performing an operation on a target electronic bill is deployed on the server 82. A bill-related party 80 can register an account with the server 82 by using the client 81 in advance to obtain a registered account only corresponding to the bill-related party 80. Then, the bill-related party 80 can log in to the registered account on the client 81. Based on the login information of the registered account on the client 81, the server 82 determines that a binding relationship is established between the registered account (corresponding to the user) and the client 81. The binding relationship that needs to be established is a binding relationship between user information of the bill-related party 80 and device information of the client 81. Based on the binding relationship, when receiving a transaction sent later by the client 81, the server 82 can determine that the transaction corresponds to the bill-related party 80.

The bill-related party 80 can input information about the target electronic bill (e.g., an ID of the target electronic bill) by using the client 81, so that the client 81 packages a transaction for performing an operation on the target electronic bill by invoking a smart contract, and sends the packaged transaction to the server 82. After receiving the transaction, the server 82 (serving as a blockchain node) invokes the smart contract to perform an operation on the target electronic bill, and publishes an operation result to the blockchain for storage.

The server 82 monitors the operation result stored on the blockchain, and when monitoring an operation result corresponding to the target electronic bill, switches the bill state of the target electronic bill in the state machine based on the monitored operation result. Similarly, when there is a state subscriber for the target electronic bill, after switching the bill state of the target electronic bill in the state machine, the server 82 can actively push a notification message that includes the current bill state of the target electronic bill to the state subscriber.

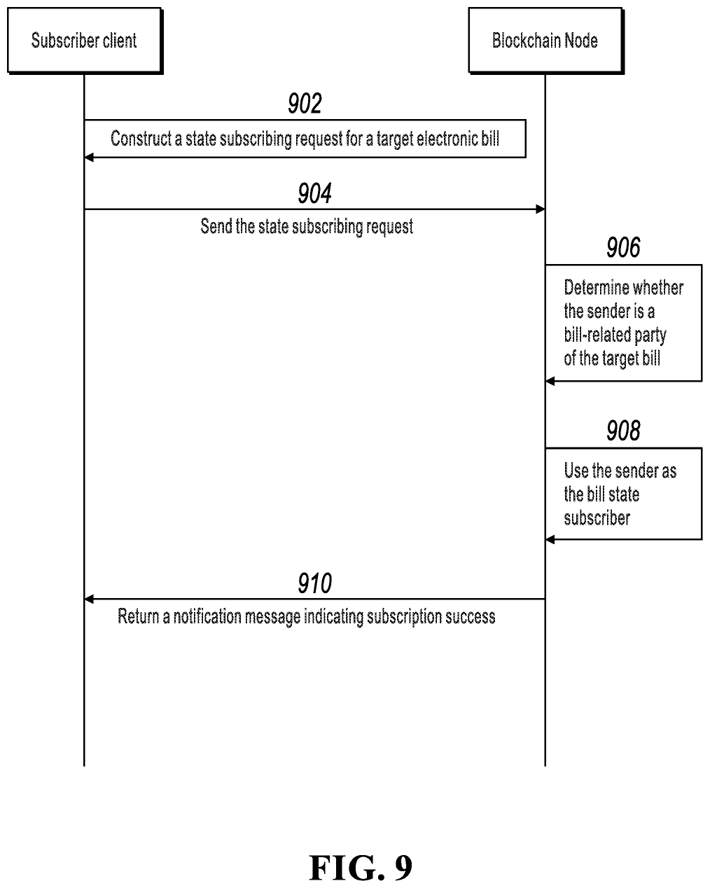

For ease of understanding, with reference to FIG. 9 to FIG. 13, the following describes in detail the technical solutions of the present specification for the operations and functions of the client and the server (serving as a blockchain node) respectively implemented in the bill state pushing process.

FIG. 9 is an interactive diagram of subscribing to a bill state, according to an example implementation. As shown in FIG. 9, the interaction process can include the following steps:

Step 902: A subscriber client constructs a state subscribing request for a target electronic bill.

In the present implementation, a user can send a state subscribing request (including an ID of the target electronic bill) to the blockchain node by using the client (connected to the blockchain node), to subscribe to an update notification for a bill state of the target electronic bill, thereby understanding a changing process of the bill state of the target electronic bill in the whole life cycle.

Each of an invoicing party, a claiming party, and a payer of the electronic bill can subscribe to the bill state by using the blockchain. When one of these parties performs a specific operation on the electronic bill, the subscriber can obtain state change information in a timely way by using the blockchain. For example, if the electronic bill of the payer is stolen and reimbursed by a person having the same name, the payer can obtain, in a timely way by using the previously described subscription mechanism, a notification message indicating that the bill has been reimbursed, thus redeeming the loss in time. For example, an electronic bill concerning medical treatment relates to such factors as remote reimbursement, multi-level reimbursement, etc., and is likely to encounter problems such as counterfeit reimbursement and duplicated claims. For example, if Tom's electronic bill is stolen and reimbursed by a person having the same name, Tom can obtain, in a timely way by using the subscription solution in the present specification, a notification message indicating that the bill has been reimbursed, thus redeeming the loss in time.

Step 904: The subscriber client sends a state subscribing request to the blockchain node.

Step 906: The blockchain node determines whether the sender is a bill-related party of the target electronic bill.

In the present implementation, whether the sender has permission to subscribe to a bill state notification is verified based on whether the sender is a bill-related party (an invoicing party, a claiming party, a supervising party, a payer, etc.). When the bill-related party subscribes to a state update of the electronic bill, if the state machine corresponding to the electronic bill is switched, a corresponding notification message is actively pushed to the bill-related party to inform the bill-related party of the latest state of the subscribed bill.

Certainly, a specific method for verifying whether the target electronic bill can be subscribed can be set flexibly based on the actual situation. For example, only the payer of the target electronic bill is allowed to subscribe, which is not limited in one or more implementations of the present specification.

Step 908: The blockchain node uses the sender of the state subscribing request as the bill state subscriber.

Step 910: The blockchain node returns a notification message indicating subscription success to the subscriber client.

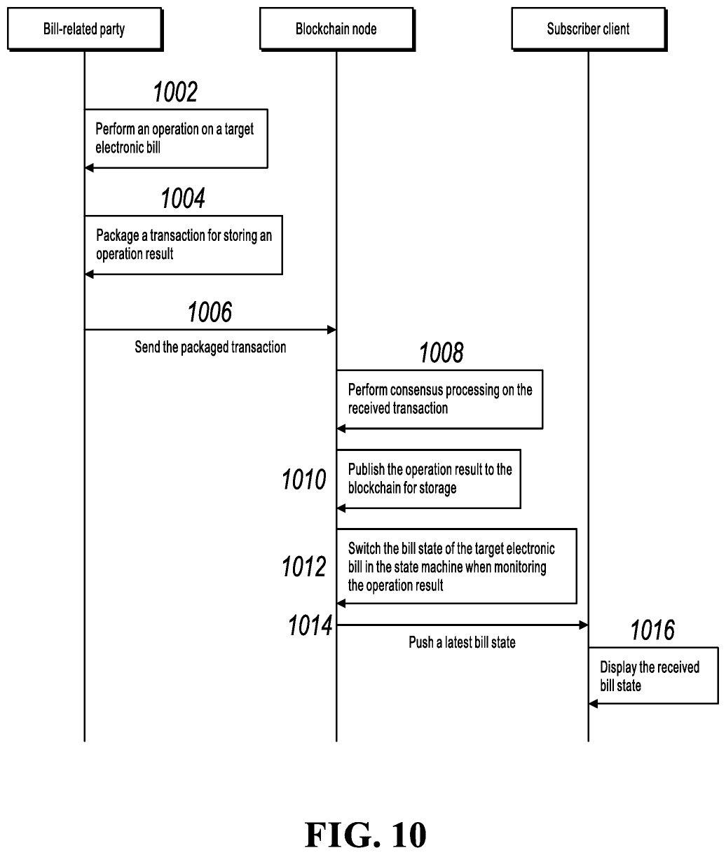

FIG. 10 is an interactive diagram illustrating a bill state pushing method, according to an example implementation. As shown in FIG. 10, the interaction process can include the following steps:

Step 1002: A bill-related party performs an operation on a target electronic bill.

In the present implementation, the bill-related party performs an operation on the electronic bill in real world, e.g., reimbursement, reversal, voiding, printing, etc.

Step 1004: The bill-related party packages a transaction for storing an operation result that is obtained after performing an operation on the target electronic bill.

Step 1006: The bill-related party sends the packaged transaction to the blockchain node.

Step 1008: The blockchain node performs consensus processing on the received transaction.

In the present implementation, a user client used by the bill-related party to access the blockchain can package the operation result into a standard transaction format supported by the blockchain and then publish the operation result to the blockchain; a node device in the blockchain can, based on the included consensus algorithm and together with other node devices, perform consensus on the transactions published by the user client to the blockchain, so as to generate a latest block for the blockchain.

The consensus algorithm supported by the blockchain includes a consensus algorithm in which a node device needs to contend for the mining right of each round of accounting period, and a consensus algorithm in which a mining node is elected in advance for each round of accounting period (there is no need to contend for the mining right).

For example, the former is represented by consensus algorithms such as Proof of Work (POW), Proof of Stake (POS), and Delegated Proof of Stake (DPOS). The latter is represented by consensus algorithms such as Practical Byzantine Fault Tolerance (PBFT).

In a blockchain network using consensus algorithms such as POW, POS, and DPOS, each of the node devices contending for the mining right can execute a transaction after receiving the transaction. One of the node devices contending for the mining right may win the current round of mining right contention and become a mining node. The mining node can package the received transaction together with other transactions to generate a latest block, and send the generated latest block to other node devices for consensus.

In a blockchain network using the consensus algorithms such as PBFT, the node device having the mining right has been agreed on before the current round of accounting. Therefore, after receiving a transaction, the node device can send the transaction to the mining node if the node device is not the mining node of the current round.

The mining node of the current round can execute the transaction when or before the transaction is packaged with other transactions to generate the latest block. After packaging the transaction together with other transactions to generate the latest block, the mining node can send the generated latest block or a block header of the latest block to other node devices for consensus.

As described previously, regardless of which type of consensus algorithm shown previously is used by the blockchain, the mining node of the current round can package the received transaction to generate the latest block, and send the generated latest block or the block header of the latest block to other node devices for consensus verification. If the verification on the latest block or the block header of the latest block received by other node devices succeeds, the latest block can be appended to the end of the original blockchain, thereby completing the blockchain accounting process.

Step 1010: The blockchain node publishes the operation result to the blockchain for storage.

Step 1012: When monitoring the operation result, the blockchain node (such as the server 72) switches the bill state of the target electronic bill in the state machine.

For example, when the bill-related party reimburses the target electronic bill, it can be determined that the electronic bill has been reimbursed, based on the reimbursement receipt (which has been published to the blockchain for storage) obtained after the reimbursement of the electronic bill, and then the state machine corresponding to the electronic bill is switched to the reimbursed state. When the operation is reversal, it can be determined that the electronic bill has been reversed, based on the reversal receipt (which has been published to the blockchain for storage) obtained after the reversal of the electronic bill, and then the state machine corresponding to the electronic bill is switched to the reverse invoice issued state. A case in which the operation is of another operation type is similar to the previous example, and details are omitted here for simplicity.

Step 1014: The blockchain node pushes a latest bill state to the subscriber client.

Step 1016: The subscriber client displays the received bill state.

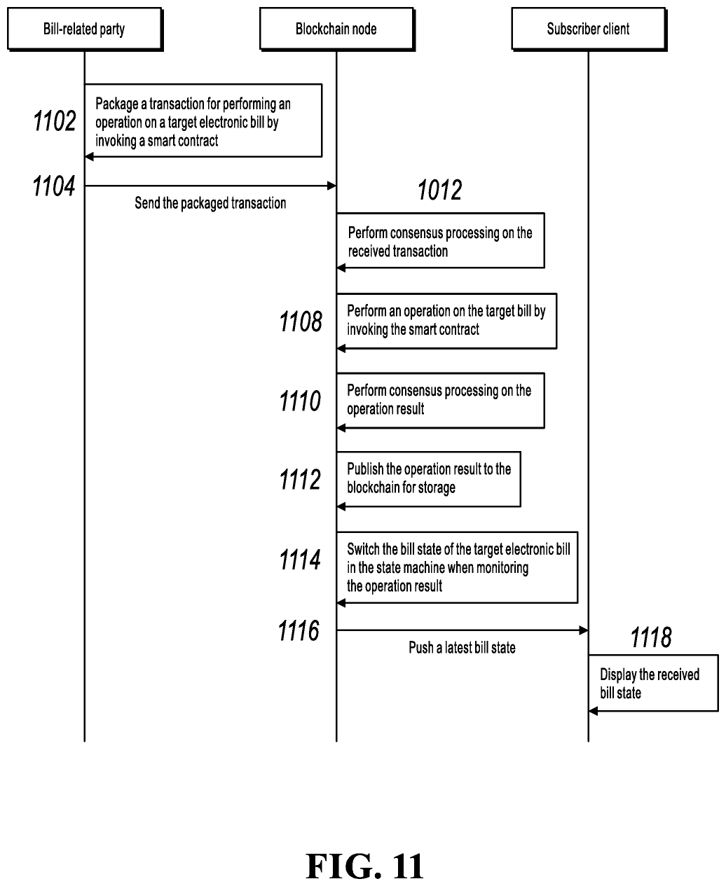

FIG. 11 is an interactive diagram illustrating another bill state pushing method, according to an example implementation. As shown in FIG. 11, the interaction process can include the following steps:

Step 1102: The bill-related party packages a transaction for performing an operation on the target electronic bill by invoking a smart contract.

In the present implementation, the electronic bill is reimbursed, reversed, voided, printed, etc. by using the smart contract deployed on the blockchain.

Step 1104: The bill-related party sends the packaged transaction to the blockchain node.

Step 1106: The blockchain node performs consensus processing on the received transaction.

Step 1108: After the consensus is reached, the blockchain node performs an operation on the target electronic bill by invoking a bill processing logic declared in the smart contract that's published on the blockchain.

The consortium blockchain is used as an example. A member of the consortium blockchain can deploy a smart contract on the consortium blockchain for performing an operation on the electronic bill, and declare a bill processing logic in the smart contract. After the development of the smart contract is completed, the member of the consortium blockchain can publish the smart contract to the consortium blockchain by using any node device on the consortium blockchain, and store the smart contract in a distributed database (i.e., a distributed ledger) of the consortium blockchain after the smart contract is agreed upon by some designated member node devices on the consortium blockchain (e.g., some authoritative node devices having the mining right specified on the consortium blockchain). Later, a user can access a client of any node device and submit a transaction to the smart contract stored on the consortium blockchain, to initiate invoking of the smart contract and trigger execution of a related service logic on the consortium blockchain.

For example, the previously described consortium blockchain can be a consortium blockchain whose members include an invoicing company, a fiscal supervising company, and a claiming company. In such case, the invoicing company can deploy, on the consortium blockchain, a smart contract that declares a service logic for voiding, reversing, or printing the electronic bill. The claiming company can deploy, on the consortium blockchain, a smart contract that declares a service logic for reimbursing the electronic bill. Multiple service logics can be declared in the same smart contract (i.e., there is a “one-to-many” relationship between the smart contract and the service logic), or different service logics can be declared in each smart contract (i.e., there is a “one-to-one” relationship between the smart contract and the service logic), which is not limited in one or more implementations of the present specification.

Step 1110: The blockchain node performs consensus processing on the operation result.

For the consensus process in the present implementation, references can be made to the consensus process in the implementation shown in FIG. 10, and details are omitted here for simplicity.

Step 1112: After the consensus is reached, the blockchain node publishes the operation result to the blockchain for storage.

Step 1114: When monitoring the operation result, the blockchain node (such as the server 82) switches the bill state of the target electronic bill in the state machine.

Step 1116: The blockchain node pushes a latest bill state to the subscriber client.

Step 1118: The subscriber client displays the received bill state.

Based on the state machine maintenance, in addition to subscribing to the bill state, the bill-related party can further actively send a query request for the bill state of the target electronic bill to the blockchain node by using the client, to obtain the current state of the target electronic bill.

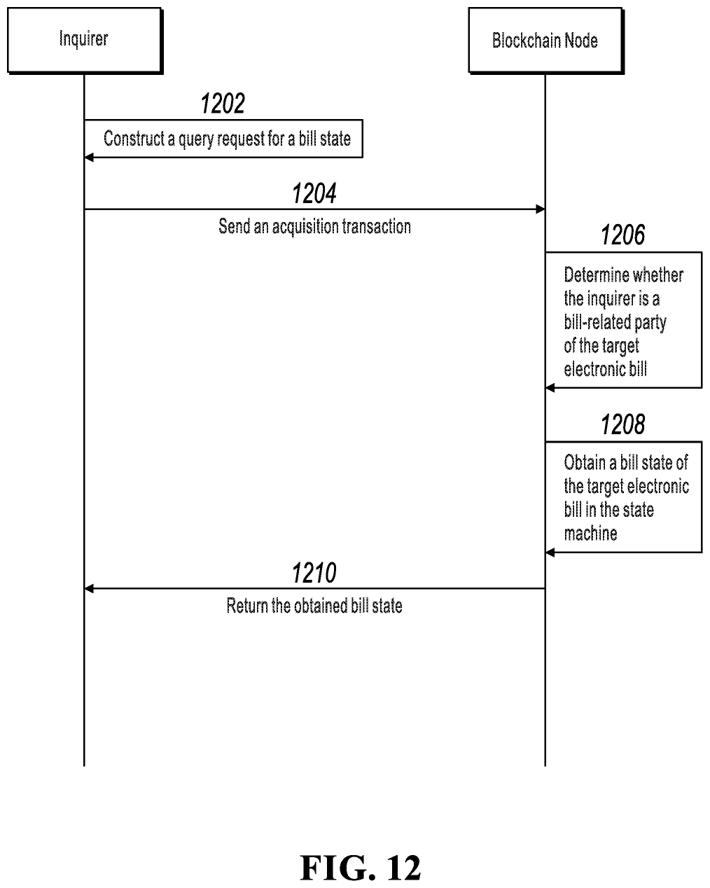

FIG. 12 is an interactive diagram of obtaining a bill state, according to an example implementation. As shown in FIG. 12, the interaction process can include the following steps:

Step 1202: The inquirer constructs a query request for the bill state of the target electronic bill. For example, the query request can include the ID of the target electronic bill.

Step 1204: The inquirer sends the query request to the blockchain node.

Step 1206: The blockchain node determines whether the sender is a bill-related party of the target electronic bill.

In the present implementation, it can be set that only the bill-related party has permission to obtain the bill state. Certainly, a permission setting method can be set flexibly based on the actual situation, which is not limited in one or more implementations of the present specification. For example, it can also be set that only a supervising party (e.g., a fiscal supervising company) among the bill-related parties has permission to obtain the bill state. The operation of determining whether to have permission to obtain the bill state can be performed by a smart contract. For example, a smart contract is deployed on the blockchain. The smart contract declares a service logic for verifying whether the sender is in a predetermined permission list (which records members that have permission to obtain the bill state).

Step 1208: Obtain the bill state of the target electronic bill in the state machine if the inquirer is a bill-related party of the target electronic bill.

Step 1210: The blockchain node returns the obtained bill state to the inquirer.

In the technical solutions of the present specification, based on the previously described state machine maintenance process, when the operation is to reimburse, a reimbursement locking mechanism can be further set with reference to the current bill state of the electronic bill recorded by the state machine, to prevent multiple bill-related parties from reimbursing the target electronic bill repeatedly.

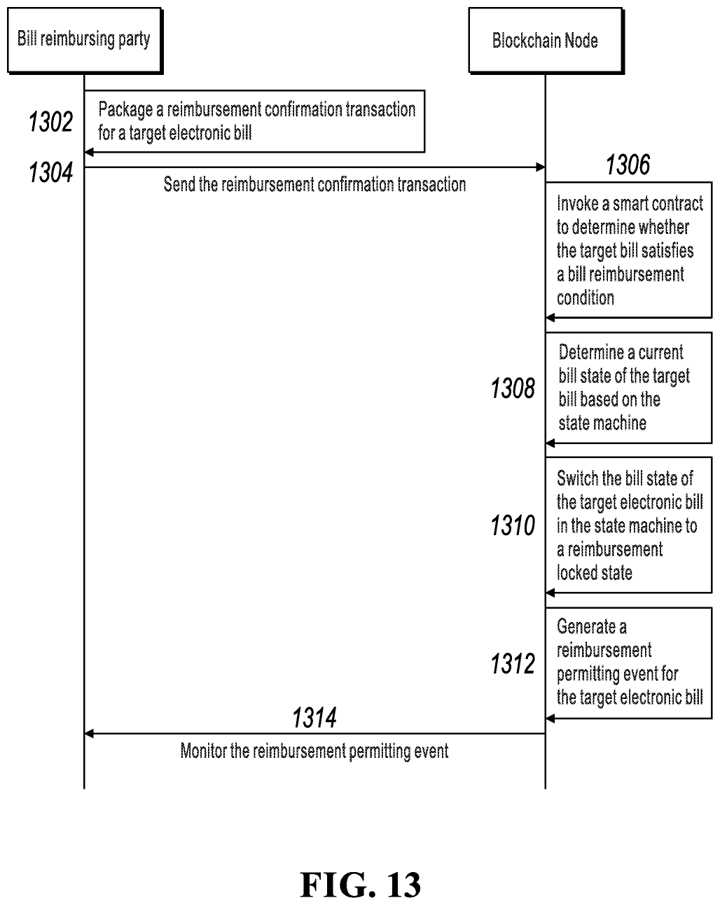

FIG. 13 is an interactive diagram illustrating reimbursement verification, according to an example implementation. As shown in FIG. 13, the interaction process can include the following steps:

Step 1302: A bill reimbursing party packages a reimbursement confirmation transaction for a target electronic bill.

In the present implementation, before reimbursing the target electronic bill, the bill reimbursing party can send a reimbursement confirmation transaction for the target electronic bill to the blockchain node, to confirm whether the target electronic bill is allowed to be reimbursed. (which is, confirm whether the target electronic bill is locked).

Step 1304: The bill reimbursing party sends the reimbursement confirmation transaction to the blockchain node.

Step 1306: The blockchain node invokes a smart contract to determine whether the target electronic bill satisfies a bill reimbursement condition. In the present implementation, the bill reimbursement condition can be pre-defined to verify whether the electronic bill satisfies reimbursement needs.

For example, the bill reimbursement condition can be pre-defined based on dimensions such as reimbursement permission, reimbursement amount, and reimbursement period. For example, it can be set that only the payer of the electronic bill has the reimbursement permission, the reimbursement amount is less than RMB 100,000 yuan, and the reimbursement period is set to be within 180 days from the transaction time corresponding to the electronic bill.

Then, a smart contract can be deployed on the blockchain. The smart contract declares a reimbursement verification logic for verifying whether the electronic bill satisfies the bill reimbursement condition. The deployment process is similar to the previously described smart contract deployment process, and details are omitted here for simplicity.

Step 1308: After determining that the target electronic bill satisfies the bill reimbursement condition, the blockchain node determines a current bill state of the target electronic bill based on the state machine.

Step 1310: When the determined bill state is an unreimbursed state, the blockchain node switches the bill state of the target electronic bill in the state machine to the reimbursement locked state.

Step 1312: The blockchain node generates a reimbursement permitting event for the target electronic bill.

Step 1314: The bill reimbursing party monitors the reimbursement permitting event.

In the present implementation, when monitoring the reimbursement permitting event, the bill reimbursing party can confirm that the target electronic bill is allowed to be reimbursed, and then perform a subsequent reimbursement operation. The target electronic bill can be reimbursed by using the method shown in FIG. 10 or FIG. 11.

When the determined bill state is a reimbursement locked state (indicating that another bill reimbursing party has previously initiated reimbursement for the target electronic bill), a reimbursement prohibiting event for the target electronic bill can be generated to indicate to the bill reimbursing party that the target electronic bill is in the reimbursement locked state, that is to say, reimbursement for the target electronic bill is prohibited (if the bill reimbursing party reimburses the target electronic bill, duplicated claims occur). When monitoring the reimbursement prohibiting event, the bill reimbursing party can confirm that the target electronic bill is prohibited from being reimbursed.

In the present implementation, the previously described step of verifying whether the target electronic bill satisfies the bill reimbursement condition can be performed after it is confirmed that the target electronic bill is allowed to be reimbursed. In other words, the sequences of steps 1308 and 1310 and step 1306 are interchanged. In such case, when the verification indicates that the target electronic bill does not satisfy the bill reimbursement condition, the bill state of the target electronic bill in the state machine is further switched from the reimbursement locked state to the unreimbursed state.

Operations on a conventional electronic bill are separated, such as issuing, voiding, printing (by using a blank template bill), reimbursing, and posting. For example, when a patient initiates reimbursement to an insurance company, the insurance company is unable to confirm whether the electronic bill has been voided or reversed. Similarly, when the patient is refunded in a hospital, the hospital is also unable to confirm whether the patient has made reimbursement at a claiming company such as a medical insurance entity or an insurance company. In the implementations of the present specification, based on the distributed ledger characteristics of the blockchain, the bill-related parties jointly maintain the bill states of the electronic bill, the state machine is maintained to enable the bill-related parties to obtain the latest state of the target electronic bill, and the reimbursement locking mechanism and the reimbursement verification process are used to prevent cashing-out acts such as duplicated claims, voided reimbursement, and reimbursement voiding.

As can be seen from the previous technical solutions, the blockchain node maintains multiple bill states of the electronic bill in the whole life cycle, so that the participants who create the blockchain can jointly maintain the bill states of the electronic bill on the blockchain through consensus, and understand the current state of the electronic bill by using the blockchain, thus determining whether a specific operation can be performed on the electronic bill. For example, before reimbursing an electronic bill, a reimbursing company can query whether the electronic bill has been reimbursed, voided, reversed, etc. by using the state machine maintained on the blockchain, thus improving the efficiency of reimbursing the electronic bill, and alleviating problems such as duplicated claims and reimbursement error.

Further, based on the bill-related party's subscription mechanism for the electronic bill, when the bill state of the target electronic bill in the state machine is switched, a notification message is actively pushed to the bill state subscriber, so as to inform the bill state subscriber of the latest state change of the subscribed bill. For example, each of an invoicing party, a claiming party, and a payer of the electronic bill can subscribe to the bill state of the electronic bill by using the blockchain. When one of these parties performs a specific operation on the electronic bill, the subscriber can obtain state change information in a timely way by using the blockchain. For example, if the electronic bill of the payer is stolen and reimbursed by a person having the same name, the payer can obtain, in a timely way by using the previously described subscription mechanism, a notification message indicating that the bill has been reimbursed, thus redeeming the loss in time.

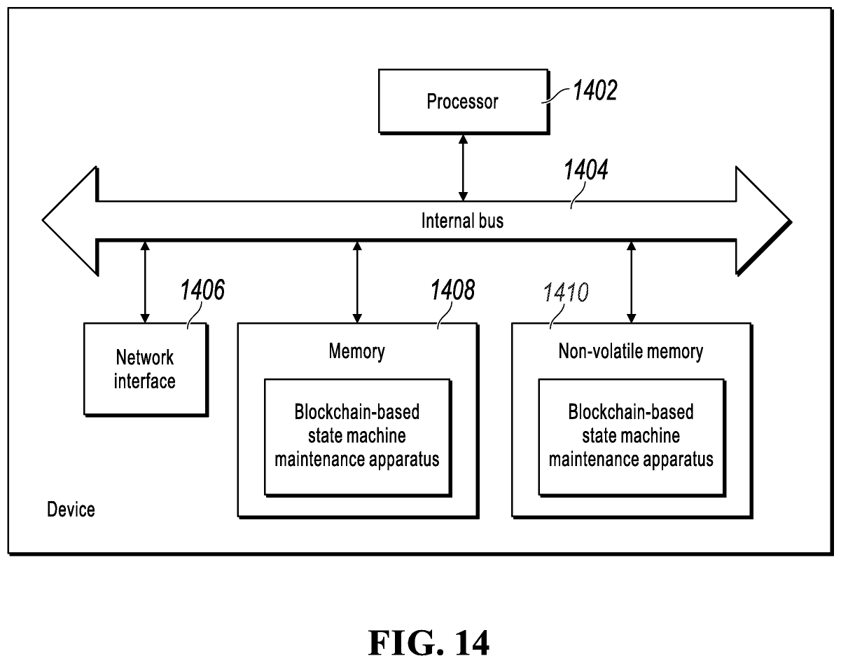

FIG. 14 is a schematic structural diagram illustrating a device, according to an example implementation. References are made to FIG. 14. At the hardware level, the device includes a processor 1402, an internal bus 1404, a network interface 1406, a memory 1408, and a non-volatile memory 1410, and certainly may further include other hardware needed by a service. The processor 1402 reads a corresponding computer program from the non-volatile memory 1410 to the memory 1408 and then runs the computer program to form a blockchain- based state machine maintenance apparatus at the logic level. Certainly, in addition to software implementations, one or more implementations of the present specification do not preclude other implementations, such as a logic device or a combination of software and hardware. In other words, an execution body of the following processing procedure is not limited to each logical unit, and can be hardware or a logic device.

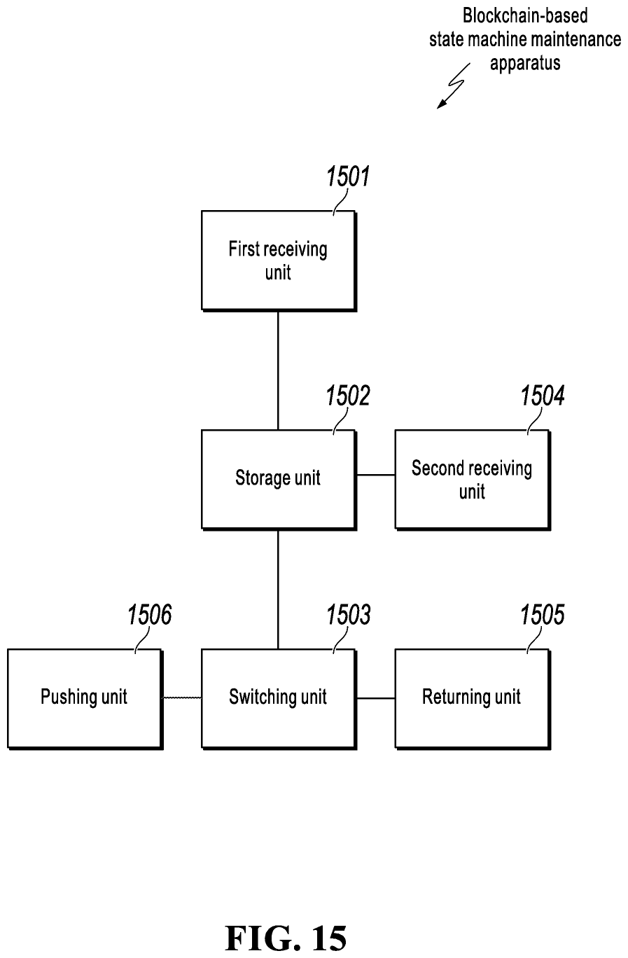

References are made to FIG. 15. In the software implementations, the blockchain-based state machine maintenance apparatus is applied to a blockchain node; the blockchain node maintains a state machine corresponding to an electronic bill stored on the blockchain; the state machine includes multiple bill states in a life cycle of the electronic bill, and operation data for triggering switching of the electronic bill from one bill state to another; and the apparatus can include the following: a first receiving unit 1501, configured to receive an operation transaction for a target electronic bill; a storage unit 1502, configured to: in response to the operation transaction, publish operation data that passed consensus and is relating to the operation transaction for the target electronic bill to the blockchain for storage; and a switching unit 1503, configured to: when monitoring that the operation data for the target electronic bill has been stored on the blockchain, determine whether the monitored operation data matches the operation data in the state machine; and if yes, switch a bill state of the target electronic bill in the state machine based on the monitored operation data.

Optionally, the operation transaction is a ledger transaction that includes the operation data for performing an operation on the target electronic bill; the operation data relating to the operation transaction for the target electronic bill is the operation data included in the operation transaction; and the storage unit 1502 is configured to: in response to the operation transaction, publish the operation transaction that passed consensus to the blockchain for storage. Optionally, the operation transaction is a transaction for invoking a smart contract; the operation data relating to the operation transaction for the target electronic bill is operation data generated by performing an operation on the target electronic bill by invoking the smart contract; and the storage unit 1502 is configured to: perform an operation on the target electronic bill by invoking a bill processing logic declared in the smart contract that's published on the blockchain; and publish the operation data generated by performing an operation on the target electronic bill to the blockchain for storage.

Optionally, the apparatus further includes the following: a second receiving unit 1504, configured to receive a query request that is sent by an inquirer for a bill state of the target electronic bill; and a returning unit 1505, configured to obtain a current bill state of the target electronic bill in the state machine, and return the obtained bill state to the inquirer.

Optionally, the apparatus further includes the following: a pushing unit 1506, configured to: if the bill state of the target electronic bill in the state machine is switched, push the switched bill state of the electronic bill to a bill state subscriber corresponding to the state machine.

Optionally, the pushing unit 1506 is specifically configured to: receive a state subscribing request for the target electronic bill; determine whether a sender of the state subscribing request is a bill-related party of the target electronic bill; and if yes, use the sender as the bill state subscriber.

Optionally, states of the state machine include an unreimbursed state, a reimbursement locked state, a reimbursed state, a posted state, a reverse invoice issued state, a printed state, and a voided state in the life cycle of the electronic bill; the operation data for switching the bill state of the target electronic bill in the state machine from the unreimbursed state to the reimbursement locked state is triggered as identification information of the target electronic bill included in a reimbursement transaction for the target electronic bill; the operation data for switching the bill state of the target electronic bill in the state machine from the reimbursement locked state to the reimbursed state is triggered as a reimbursement result for the target electronic bill; the operation data for switching the bill state of the target electronic bill in the state machine from the reimbursed state to the posted state is triggered as a posting result for the target electronic bill; the operation data for switching the bill state of the target electronic bill in the state machine from the unreimbursed state to the reverse invoice issued state is triggered as a reversal result for the target electronic bill; the operation data for switching the bill state of the target electronic bill in the state machine from the unreimbursed state to the printed state is triggered as a printing result for the target electronic bill; and the operation data for switching the bill state of the target electronic bill in the state machine from the unreimbursed state to the voided state is triggered as a voiding result for the target electronic bill.

The system, apparatus, module, or unit illustrated in the previous implementations can be implemented by using a computer chip or an entity, or can be implemented by using a product having a certain function. A typical implementation device is a computer, and the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

In a typical configuration, a computer includes one or more processors (CPU), one or more input/output interfaces, one or more network interfaces, and one or more memories.

The memory may include a non-persistent memory, a random access memory (RAM), a non-volatile memory, and/or another form that are in a computer readable medium, for example, a read-only memory (ROM) or a flash memory (flash RAM). The memory is an example of the computer readable medium.

The computer readable medium includes persistent, non-persistent, movable, and unmovable media that can store information by using any method or technology. The information can be a computer readable instruction, a data structure, a program module, or other data. Examples of a computer storage medium include but are not limited to a phase change random access memory (PRAM), a static RAM (SRAM), a dynamic RAM (DRAM), a RAM of another type, a read-only memory (ROM), an electrically erasable programmable ROM (EEPROM), a flash memory or another memory technology, a compact disc ROM (CD-ROM), a digital versatile disc (DVD) or another optical storage, a cassette tape, a magnetic disk storage, a quantum memory, a storage medium based on grapheme, another magnetic storage device, or any other non-transmission medium. The computer storage medium can be used to store information that can be accessed by the computing device. Based on the definition in the present specification, the computer readable medium does not include transitory media such as a modulated data signal and carrier.

It is worthwhile to further note that, the terms “include”, “contain”, or their any other variants are intended to cover a non-exclusive inclusion, so a process, a method, a product or a device that includes a list of elements not only includes those elements but also includes other elements which are not expressly listed, or further includes elements inherent to such process, method, product or device. Without more constraints, an element preceded by “includes a . . . ” does not preclude the existence of additional identical elements in the process, method, product or device that includes the element.

The specific implementations of the present specification are described previously. Other implementations fall within the scope of the appended claims. In some situations, the actions or steps described in the claims can be performed in an order different from the order in the implementations and the desired results can still be achieved. In addition, the process depicted in the accompanying drawings does not necessarily need a particular execution order to achieve the desired results. In some implementations, multi-tasking and concurrent processing is feasible or can be advantageous.

Terms used in one or more implementations of the present specification are merely used to describe specific implementations, and are not intended to limit the one or more implementations of the present specification. The terms “a” and “the” of singular forms used in one or more implementations of the present specification and the appended claims are also intended to include plural forms, unless otherwise specified in the context clearly. It should be further understood that the term “and/or” used in the present specification indicates and includes any or all possible combinations of one or more associated listed items.

It should be understood that although terms “first”, “second”, “third”, etc. can be used in one or more implementations of the present specification to describe various types of information, the information is not limited to these terms. These terms are only used to differentiate between information of the same type. For example, without departing from the scope of one or more implementations of the present specification, first information can also be referred to as second information, and similarly, the second information can be referred to as the first information. Depending on the context, for example, the word “if” used here can be explained as “while”, “when”, or “in response to determining”.

The previous descriptions are only example implementations of one or more implementations of the present specification, but are not intended to limit the one or more implementations of the present specification. Any modification, equivalent replacement, improvement, etc. made without departing from the spirit and principle of the one or more implementations of the present specification shall fall within the protection scope of the one or more implementations of the present specification.

What is claimed is:

1. A computer-implemented method comprising:
receiving, by a blockchain node, an operation transaction for a target electronic bill, wherein the blockchain node maintains a state machine corresponding to an electronic bill stored on a blockchain, wherein the state machine comprises multiple bill states in a life cycle of the electronic bill and operation data for triggering switching of the electronic bill from one bill state to another;
in response to receiving the operation transaction, initiating a consensus process for the operation transaction;
publishing consensus data related to the consensus process based on the operation transaction for the target electronic bill to the blockchain;
determining monitored operation data matches the operation data in the state machine; and
switching a bill state of the target electronic bill in the state machine based on the monitored operation data.

2. The computer-implemented method of claim 1, wherein the operation transaction is a ledger transaction that comprises the operation data, wherein the operation data is used to perform an operation on the target electronic bill, and wherein publishing the consensus data related to the consensus process based on the operation transaction for the target electronic bill to the blockchain comprises:
publishing the operation transaction to the blockchain.

3. The computer-implemented method of claim 1, wherein the operation transaction comprises a transaction for invoking a smart contract, wherein the operation data relating to the operation transaction for the target electronic bill is generated by invoking the smart contract on the target electronic bill, and wherein publishing the consensus data related to the consensus process based on the operation transaction for the target electronic bill to the blockchain comprises:
performing an operation on the target electronic bill by invoking a bill processing logic declared in the smart contract published on the blockchain; and
publishing the operation data generated by performing the operation on the target electronic bill to the blockchain.

4. The computer-implemented method of claim 1, further comprising:
receiving a query request sent by an inquirer for the bill state of the target electronic bill;
obtaining one or more values related to the bill state of the target electronic bill in the state machine; and
sending the one or more values related to the bill state to the inquirer.

5. The computer-implemented method of claim 1, further comprising:
determining the bill state of the target electronic bill in the state machine is switched; and
sending one or more values related to the bill state of the electronic bill to a bill state subscriber corresponding to the state machine.

6. The computer-implemented method of claim 5, further comprising:
receiving a state subscribing request for the target electronic bill;
determining a sender of the state subscribing request is a bill-related party of the target electronic bill; and
using the sender as the bill state subscriber.

7. The computer-implemented method of claim 1, wherein the multiple bill states comprise an unreimbursed state, a reimbursement locked state, a reimbursed state, a posted state, a reverse invoice issued state, a printed state, and a voided state in the life cycle of the electronic bill;
wherein the operation data for switching the bill state of the target electronic bill in the state machine from the unreimbursed state to the reimbursement locked state is triggered by identification information of the target electronic bill comprised in a reimbursement transaction for the target electronic bill;
wherein the operation data for switching the bill state of the target electronic bill in the state machine from the reimbursement locked state to the reimbursed state is triggered by a reimbursement result for the target electronic bill;
wherein the operation data for switching the bill state of the target electronic bill in the state machine from the reimbursed state to the posted state is triggered by a posting result for the target electronic bill;
wherein the operation data for switching the bill state of the target electronic bill in the state machine from the unreimbursed state to the reverse invoice issued state is triggered by a reversal result for the target electronic bill;
wherein the operation data for switching the bill state of the target electronic bill in the state machine from the unreimbursed state to the printed state is triggered by a printing result for the target electronic bill; and
wherein the operation data for switching the bill state of the target electronic bill in the state machine from the unreimbursed state to the voided state is triggered by a voiding result for the target electronic bill.

8. A non-transitory, computer-readable medium storing one or more instructions executable by a computer system to perform operations comprising:
receiving, by a blockchain node, an operation transaction for a target electronic bill, wherein the blockchain node maintains a state machine corresponding to an electronic bill stored on a blockchain, wherein the state machine comprises multiple bill states in a life cycle of the electronic bill and operation data for triggering switching of the electronic bill from one bill state to another;
in response to receiving the operation transaction, initiating a consensus process for the operation transaction;
publishing consensus data related to the consensus process based on the operation transaction for the target electronic bill to the blockchain;
determining monitored operation data matches the operation data in the state machine; and
switching a bill state of the target electronic bill in the state machine based on the monitored operation data.

9. The non-transitory, computer-readable medium of claim 8, wherein the operation transaction is a ledger transaction that comprises the operation data, wherein the operation data is used to perform an operation on the target electronic bill, and
wherein publishing the consensus data related to the consensus process based on the operation transaction for the target electronic bill to the blockchain comprises:
publishing the operation transaction to the blockchain.

10. The non-transitory, computer-readable medium of claim 8, wherein the operation transaction comprises a transaction for invoking a smart contract, wherein the operation data relating to the operation transaction for the target electronic bill is generated by invoking the smart contract on the target electronic bill, and wherein publishing the consensus data related to the consensus process based on the operation transaction for the target electronic bill to the blockchain comprises:
performing an operation on the target electronic bill by invoking a bill processing logic declared in the smart contract published on the blockchain; and
publishing the operation data generated by performing the operation on the target electronic bill to the blockchain.

11. The non-transitory, computer-readable medium of claim 8, further comprising:
receiving a query request sent by an inquirer for the bill state of the target electronic bill;
obtaining one or more values related to the bill state of the target electronic bill in the state machine; and
sending the one or more values related to the bill state to the inquirer.

12. The non-transitory, computer-readable medium of claim 8, further comprising:
determining the bill state of the target electronic bill in the state machine is switched; and
sending one or more values related to the bill state of the electronic bill to a bill state subscriber corresponding to the state machine.

13. The non-transitory, computer-readable medium of claim 12, further comprising:
receiving a state subscribing request for the target electronic bill;
determining a sender of the state subscribing request is a bill-related party of the target electronic bill; and
using the sender as the bill state subscriber.

14. The non-transitory, computer-readable medium of claim 8, wherein the multiple bill states comprise an unreimbursed state, a reimbursement locked state, a reimbursed state, a posted state, a reverse invoice issued state, a printed state, and a voided state in the life cycle of the electronic bill;
wherein the operation data for switching the bill state of the target electronic bill in the state machine from the unreimbursed state to the reimbursement locked state is triggered by identification information of the target electronic bill comprised in a reimbursement transaction for the target electronic bill;
wherein the operation data for switching the bill state of the target electronic bill in the state machine from the reimbursement locked state to the reimbursed state is triggered by a reimbursement result for the target electronic bill;
wherein the operation data for switching the bill state of the target electronic bill in the state machine from the reimbursed state to the posted state is triggered by a posting result for the target electronic bill;
wherein the operation data for switching the bill state of the target electronic bill in the state machine from the unreimbursed state to the reverse invoice issued state is triggered by a reversal result for the target electronic bill;
wherein the operation data for switching the bill state of the target electronic bill in the state machine from the unreimbursed state to the printed state is triggered by a printing result for the target electronic bill; and
wherein the operation data for switching the bill state of the target electronic bill in the state machine from the unreimbursed state to the voided state is triggered by a voiding result for the target electronic bill.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving, by a blockchain node, an operation transaction for a target electronic bill, wherein the blockchain node maintains a state machine corresponding to an electronic bill stored on a blockchain, wherein the state machine comprises multiple bill states in a life cycle of the electronic bill and operation data for triggering switching of the electronic bill from one bill state to another;
in response to receiving the operation transaction, initiating a consensus process for the operation transaction;
publishing consensus data related to the consensus process based on the operation transaction for the target electronic bill to the blockchain;
determining monitored operation data matches the operation data in the state machine; and
switching a bill state of the target electronic bill in the state machine based on the monitored operation data.

16. The computer-implemented system of claim 15, wherein the operation transaction is a ledger transaction that comprises the operation data, wherein the operation data is used to perform an operation on the target electronic bill, and
wherein publishing the consensus data related to the consensus process based on the operation transaction for the target electronic bill to the blockchain comprises:
publishing the operation transaction to the blockchain.

17. The computer-implemented system of claim 15, wherein the operation transaction comprises a transaction for invoking a smart contract, wherein the operation data relating to the operation transaction for the target electronic bill is generated by invoking the smart contract on the target electronic bill, and wherein publishing the consensus data related to the consensus process based on the operation transaction for the target electronic bill to the blockchain comprises:
performing an operation on the target electronic bill by invoking a bill processing logic declared in the smart contract published on the blockchain; and
publishing the operation data generated by performing the operation on the target electronic bill to the blockchain.

18. The computer-implemented system of claim 15, further comprising:
receiving a query request sent by an inquirer for the bill state of the target electronic bill;
obtaining one or more values related to the bill state of the target electronic bill in the state machine; and
sending the one or more values related to the bill state to the inquirer.

19. The computer-implemented system of claim 15, further comprising:
determining the bill state of the target electronic bill in the state machine is switched; and
sending one or more values related to the bill state of the electronic bill to a bill state subscriber corresponding to the state machine.

20. The computer-implemented system of claim 19, further comprising:
receiving a state subscribing request for the target electronic bill;
determining a sender of the state subscribing request is a bill-related party of the target electronic bill; and
using the sender as the bill state subscriber.

21. The computer-implemented system of claim 15, wherein the multiple bill states comprise an unreimbursed state, a reimbursement locked state, a reimbursed state, a posted state, a reverse invoice issued state, a printed state, and a voided state in the life cycle of the electronic bill;
wherein the operation data for switching the bill state of the target electronic bill in the state machine from the unreimbursed state to the reimbursement locked state is triggered by identification information of the target electronic bill comprised in a reimbursement transaction for the target electronic bill;
wherein the operation data for switching the bill state of the target electronic bill in the state machine from the reimbursement locked state to the reimbursed state is triggered by a reimbursement result for the target electronic bill;
wherein the operation data for switching the bill state of the target electronic bill in the state machine from the reimbursed state to the posted state is triggered by a posting result for the target electronic bill;
wherein the operation data for switching the bill state of the target electronic bill in the state machine from the unreimbursed state to the reverse invoice issued state is triggered by a reversal result for the target electronic bill;
wherein the operation data for switching the bill state of the target electronic bill in the state machine from the unreimbursed state to the printed state is triggered by a printing result for the target electronic bill; and
wherein the operation data for switching the bill state of the target electronic bill in the state machine from the unreimbursed state to the voided state is triggered by a voiding result for the target electronic bill.
